(19) United States
(12) Patent Application Publication
(10) Pub. No.: US 2024/0125616 A1
(43) Pub. Date: Apr. 18, 2024

(54) SYSTEM AND METHOD OF REDUCING GPS NOISE AND CORRECTING VEHICLE GPS TRAJECTORY FOR A HIGH-DEFINITION MAP

(71) Applicant: GM Global Technology Operations LLC, Detroit, MI (US)

(72) Inventors: Bo Yu, Troy, MI (US); Joon Hwang, Pflugerville, TX (US); Carl P. Darukhanavala, Royal Oak, MI (US); Shu Chen, Rochester Hills, MI (US); Vivek Vijaya Kumar, Shelby Township, MI (US); Donald K. Grimm, Utica, MI (US); Fan Bai, Ann Arbor, MI (US)

(21) Appl. No.: 18/045,306

(22) Filed: Oct. 10, 2022

(51) Int. Cl. G01C 21/00

(52) U.S. Cl. CPC G01C 21/3819; G01C 21/387; G01C 21/3889

(57) ABSTRACT

A method of correcting a GPS vehicle trajectory of a vehicle on a roadway for a high-definition map is provided. The method comprises receiving first bitmap data from a first sensor of a first vehicle to create a plurality of first multi-layer bitmaps for the first vehicle using the first bitmap data and receiving second bitmap data from a plurality of second sensors of a plurality of second vehicles to create a plurality of second multi-layer bitmaps. The method further comprises creating first probability density bitmaps and an overall probability density bitmap with a probability density estimation, and matching an image template from each of the first probability density bitmaps with the overall probability density bitmap to define match results. The method further comprises combining the match results to define combined utility values and determining the maximal utility value with the combined utility values.

### INTRODUCTION

The present disclosure relates to systems and methods for reducing GPS noise for high-definition (HD) maps and, more particularly, systems and methods for correcting GPS vehicle trajectory of a vehicle on a roadway for constructing an HD map using probability density bitmaps and template matching.

Currently, HD maps are created using aerial or satellite imaging. Aerial imaging and satellite imaging are, however, relatively expensive and sometimes also inaccurate when there is occlusion from trees and buildings. In addition, constructing HD maps using aerial or satellite imaging may require human labeling. Some HD maps may be constructed by way of crowdsourcing, but computing overhead and GPS data error or noise may be issues.

### SUMMARY

Thus, while current systems and methods achieve their intended purpose, there is a need for a new and improved system and method for reducing GPS noise and correcting GPS trajectory of a vehicle on a roadway for an HD map.

The present disclosure describes systems and methods for reducing GPS noise and correcting GPS vehicle trajectory in relation to an HD map of a roadway. The systems and methods described herein improve technology relating to the navigation of autonomous vehicles by reducing GPS noise and correcting vehicle GPS trajectory, thereby improving the HD map of the roadway. Improvements are made to lane line accuracy using crowdsourcing from numerous vehicles.

In accordance with one aspect of the present disclosure, a method of correcting a GPS vehicle trajectory of a vehicle on a roadway for a high-definition map is provided. The method comprises receiving first bitmap data from a first sensor of a first vehicle. The first bitmap data comprises first GPS data (vehicle GPS data) and first lane line data (sensed lane line data) of the roadway at a timestamp to create a plurality of first multi-layer bitmaps for the first vehicle using the first bitmap data. Each of the first multi-layer bitmaps has at least one lane line attribute. In the present disclosure, the term “vehicle GPS data” means data received by a controller from a GPS transceiver that is indicative of the location of the vehicle.

In this aspect, the method further comprises receiving second bitmap data from a plurality of second sensors of a plurality of second vehicles. The second bitmap data comprises second GPS data and second lane line data at the time segment of each second vehicle to create a plurality of second multi-layer bitmaps for each second vehicle using the second bitmap data.

The method further comprises creating first probability density bitmaps with the first multi-layer bitmaps and the first lane line data by way of a probability density estimation, and creating an overall probability density bitmap with the second multi-layer bitmaps and the second lane line data by way of the probability density estimation. A probability density bitmap is a bitmap data structure, and it represents a probability distribution over a geographical area. Each pixel corresponds to a specific geo-location, such as a pair of GPS latitude/longitude coordinates. The pixel value in the bitmap represents the probability of a lane line being observed at that geo-location by one or multiple vehicles.

In this aspect, the method further comprises matching an image template from each of the first probability density bitmaps with the overall probability density bitmap for the timestamp to define a plurality of match results having utility values. Moreover, each image template comprises the first lane line data of one lane line attribute. Additionally, each match result is limited along a line perpendicular to the trajectory of the first vehicle. Furthermore, each match result is centered relative to the first GPS data and first lane line data of the first vehicle to define a search scope.

The method further comprises combining the match results and utility values to define combined utility values and determining the maximal utility value with the combined utility values to correct the GPS vehicle trajectory of the first vehicle for a high-definition map.

In one example, the step of receiving the first bitmap data comprises creating the plurality of first multi-layer bitmaps for the first vehicle using the first bitmap data. Moreover, the step of receiving the second bitmap data comprises creating the plurality of second multi-layer bitmaps for each second vehicle using the second bitmap data.

In another example, the step of creating the first probability density bitmaps comprises plotting lane lines to the first multi-layer bitmaps of the first vehicle using the first lane line data to define first plotted bitmaps. Moreover, the step of creating the first probability density bitmaps comprises creating the first probability density bitmaps with the first plotted bitmaps by way of the probability density estimation.

In yet another example, the step of creating the overall probability density bitmap comprises plotting lane lines to the second multi-layer bitmaps of the second vehicles using the second lane line data to define second plotted bitmaps and merging the second plotted bitmaps of each of the second vehicles to define an overall lane line bitmap. Moreover, the step of creating the overall probability density bitmap comprises creating the overall probability density bitmap with the overall lane line bitmap by way of the probability density estimation.

In still another example, the step of matching comprises extracting the image template from each of the first probability density bitmaps. Each image template comprises the first lane line data.

In one example, the step of combining comprises combining the match results and utility values to define the combined utility value by way of:

$$util\_combined ( i , j ) = {\sum }_{layer \_ k} u t i {l}_{layer \_} k ( i , j ) , ( i , j ) ∈ search\_scope$$

where (i,j) is a pixel from the search scope, util_layer_k(i,j) is the utility value of the template matching at pixel (i,j) for a layer k, util_combined(i,j) is the combined utility value of all the layers k at pixel (i,j).

In another example, the step of determining comprises determining the maximal utility value by way of:

$$( {x}^{′} , {y}^{′} ) = {argmax}_{( i , j )} ( util\_combined ( i , j ) )$$

where argmax is a function to provide the maximal utility value of the util_combined(i,j), (x′,y′) is a corrected GPS trajectory position of the first vehicle having input (t,x,y), where t is the timestamp and (x,y) is first GPS data of the first vehicle.

In yet another example, the at least one lane line attribute comprises lane line types including yellow lane lines, white lane lines, solid lane lines, and dashed lane line. In still another example, the timestamp comprises a plurality of timestamps.

In accordance with another aspect of the present disclosure, a method of correcting a GPS vehicle trajectory on a roadway for a high-definition map is provided. The method comprises receiving first bitmap data from a first sensor of a first vehicle. The first bitmap data comprising first GPS data and first lane line data at a timestamp to create a plurality of first multi-layer bitmaps for the first vehicle using the first bitmap data. Each of the first multi-layer bitmaps having at least one lane line attribute.

The method further comprises receiving second bitmap data from a plurality of second sensors of a plurality of second vehicles. The second bitmap data comprises second GPS data and second lane line data at the timestamp of each second vehicle to create a plurality of second multi-layer bitmaps for each second vehicle using the second bitmap data.

The method further comprises plotting lane lines to the first multi-layer bitmaps of the first vehicle using the first lane line data to define first plotted bitmaps, and plotting lane lines to the second multi-layer bitmaps of the second vehicles using the second lane line data to define second plotted bitmaps. The method further comprises creating first probability density bitmaps with the first plotted bitmaps by way of a probability density estimation and merging the second plotted bitmaps of each of the second vehicles to define an overall lane line bitmap. Furthermore, the method comprises creating an overall probability density bitmap with the overall lane line bitmap by way of the probability density estimation.

The method further comprises matching an image template from each of the first probability density bitmaps with the overall probability density bitmap to define a plurality of match results having utility values. Each image template comprises the first lane line data of one lane line attribute. Each match result of each lane line attribute is limited along a line perpendicular to the trajectory of the first vehicle and each match result being centered relative to the first GPS data and first lane line data of the first vehicle to define a search scope.

The method further comprises combining the match results and utility values to define a combined utility value by way of:

$$util\_combined ( i , j ) = {\sum }_{layer \_ k} u t i {l}_{layer \_} k ( i , j ) , ( i , j ) ∈ search\_scope$$

where (i,j) is a pixel from the search scope, util_layer_k(i,j) is the utility value of the template matching at pixel (i,j) for a layer k, util_combined(i,j) is the combined utility value of all the layers k at pixel (i,j). The method further comprises determining a maximal utility value to correct the GPS vehicle trajectory of the first vehicle for a high-definition map by way of:

$$( {x}^{′} , {y}^{′} ) = {argmax}_{( i , j )} ( util\_combined ( i , j ) )$$

where argmax is a function that provides the maximal utility value of the util_combined(i,j), (x′,y′) is a corrected GPS trajectory position of the first vehicle having input (t,x,y), where t is the timestamp and (x,y) is first GPS data of the first vehicle.

In one example, the step of receiving the first bitmap data comprises creating the plurality of first multi-layer bitmaps for the first vehicle using the first bitmap data and the step of receiving the second bitmap data comprises creating the plurality of second multi-layer bitmaps for each second vehicle using the second bitmap data. In another example, the step of matching comprises extracting the image template from each of the first probability density bitmaps, each image template comprising the first lane line data.

In yet another example, the at least one lane line attribute comprises lane line types including yellow lane lines, white lane lines, solid lane lines, and dashed lane line. In still another example, the timestamp comprises a plurality of timestamps.

In accordance with yet another aspect of the present disclosure, a system for correcting a GPS vehicle trajectory on a roadway for a high-definition map is provided. The system comprises a first sensor of a first vehicle on the roadway. The first sensors are arranged to sense first bitmap data comprising first GPS data and first lane line data at a timestamp. The system further comprises a plurality of second sensors of a plurality of second vehicles on the roadway. The second sensors are arranged to sense second bitmap data comprising second GPS data and second lane line data at the time segment of each second vehicle.

The system further comprises a system controller in communication with the first vehicle and the second vehicles. The system controller comprises a computer-readable storage device arranged to receive the first bitmap data from the first vehicle and the second bitmap data from the second vehicles.

The system controller further comprises a processor in communication with the computer-readable storage device. The processor is arranged to create a plurality of first multi-layer bitmaps for the first vehicle using the first bitmap data. Moreover, each of the first multi-layer bitmaps having at least one lane line attribute and to create a plurality of second multi-layer bitmaps for each second vehicle using the second bitmap data. Additionally, the system controller is arranged to create first probability density bitmaps with the first multi-layer bitmaps and the first lane line data by way of a probability density estimation. Furthermore, the system controller is arranged to create an overall probability density bitmap with the second multi-layer bitmaps and the second lane line data by way of the probability density estimation.

In this aspect, the processor is arranged to match an image template from each of the first probability density bitmaps with the overall probability density bitmap for the timestamp defining a plurality of match results having utility values. Moreover, each image template comprises the first lane line data of one lane line attribute. Each match result is limited along a line perpendicular to the trajectory of the first vehicle and centered relative to the first GPS data and first lane line data of the first vehicle to define a search scope. Furthermore, the processor is arranged to combine the match results and utility values to define combined utility values and to determine a maximal utility value with the combined utility values for correcting the GPS vehicle trajectory of the first vehicle.

In one example, the system controller is arranged to plot lane lines to the first multi-layer bitmaps of the first vehicle using the first lane line data to define first plotted bitmaps and to create the first probability density bitmaps with the first plotted bitmaps by way of the probability density estimation. Moreover, the system controller is arranged to plot lane lines to the second multi-layer bitmaps of the second vehicles using the second lane line data to define second plotted bitmaps and merge the second plotted bitmaps of each of the second vehicles to define an overall lane line bitmap. In addition, the system controller is arranged to create the overall probability density bitmap with the overall lane line bitmap by way of the probability density estimation.

In another example, the system controller is arranged to extract the image template from each of the first probability density bitmaps, each image template comprising the first lane line data.

In yet another example, the system controller is arranged to combine the match results and utility values to define the combined utility value by way of:

$$util\_combined ( i , j ) = {\sum }_{layer \_ k} u t i {l}_{layer \_} k ( i , j ) , ( i , j ) ∈ search\_scope$$

where (i,j) is a pixel from the search scope, util_layer_k(i,j) is the utility value of the template matching at pixel (i,j) for a layer k, util_combined(i,j) is the combined utility value of all the layers k at pixel (i,j). The system controller is arranged to determine the maximal utility value by way of:

$$( {x}^{′} , {y}^{′} ) = {argmax}_{( i , j )} ( util\_combined ( i , j ) )$$

where argmax is a function to provide the maximal utility value of the util_combined(i,j), (x′,y′) is a corrected GPS trajectory position of the first vehicle having input (t,x,y), where t is the timestamp and (x,y) is first GPS data of the first vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for correcting a GPS vehicle trajectory on a roadway for a high-definition map in accordance with one embodiment of the present disclosure.

FIG. 2 is a schematic view depicting a plurality of vehicles having sensors to sense GPS data and lane line data for the system of FIG. 1.

FIG. 3 is a schematic view depicting an HD map created by the system of FIG. 1.

FIG. 4 is conceptual view of an extracted sub-image matched with an overall probability density bitmap implemented by the system in FIG. 1 in accordance with one example of the present disclosure.

FIG. 5 is a flowchart of a method of correcting the GPS trajectory of a vehicle on the roadway for the high-definition map in accordance with one example of the present disclosure.

### DETAILED DESCRIPTION

The following description is merely exemplary in nature and is not intended to limit the present disclosure, application, or uses.

Embodiments of the present disclosure are systems and methods for reducing GPS noise and correcting GPS vehicle trajectory in relation to an HD map of a roadway. The systems and methods described herein improve technology relating to the navigation of autonomous vehicles by reducing GPS noise and correcting vehicle GPS trajectory, thereby improving the HD map of the roadway. Improvements are made to lane line accuracy using crowdsourcing from numerous vehicles. Template matching is used with limited search scopes to reduce computing overhead. A maximal utility value is determined to find a corrected vehicle GPS trajectory used to improve the HD map viewed by a user of a vehicle.

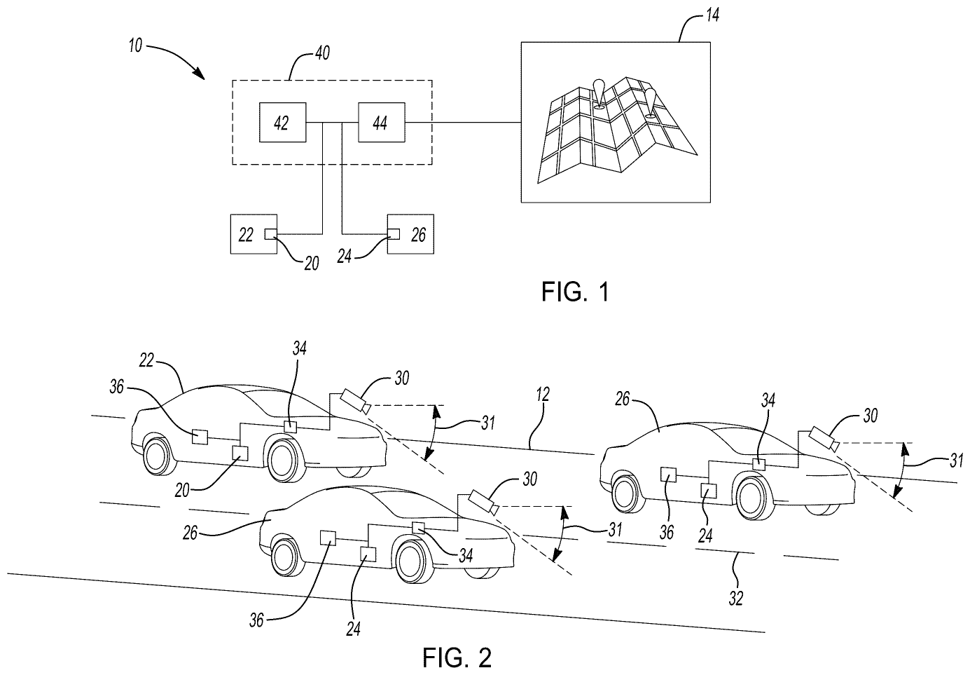

FIGS. 1 and 2 illustrate a system 10 for correcting a GPS vehicle trajectory of a vehicle on a roadway 12 for a high-definition map 14. As shown, the system 10 comprises a first sensor 20 of a first vehicle 22 on the roadway 12, a plurality of second sensors 24 of a plurality of second vehicles 26 on the roadway 12, and a system controller 40 in communication with the first vehicle 22 and the second vehicles 26. Because the vehicles are in communication with the system controller 40, the system controller 40 is programmed to receive the sensor data from the sensors (e.g., the lane line data from the cameras 30) of the vehicles.

The first sensor 20 is arranged to sense first bitmap data comprising first GPS data and first lane line data at a timestamp. The second sensors 24 are arranged to sense second bitmap data comprising second GPS data and second lane line data at the time segment of each second vehicle. As non-limiting examples, the first sensor 20 and second sensors 24 may include Global Positioning System (GPS) transceivers, yaw sensors, and speed sensors. In this embodiment, each of the vehicles 22, 26 comprise a forward-facing camera 30. The GPS transceivers are configured to detect the location of each of the first vehicle 22 and second vehicles 26. The speed sensors are configured to detect the speed of each vehicle. The yaw sensors are configured to determine the heading of each vehicle.

The cameras 30 have a field of view 31 large enough to capture images of the roadway 12 in front of the vehicles. Specifically, the cameras 30 are configured to capture images of the lane lines 32 of the roadway 12 in front of the vehicles and thereby detect the lane lines 32 of the roadway 12 in front of the vehicle. The lane line data includes lane line geometry data and lane line attribute data detected by the cameras 30 of the vehicles.

The vehicles are configured to send the sensor data from the sensors to the system controller 40 using, for example, communication transceivers. The sensor data includes GPS data and lane lines data. The GPS data may be received from the GPS transceiver. The lane line data are preferably not images. Rather, the lane line data includes lane lines 32 in the form of polynomial curves reported by the camera 30 (e.g., front camera module) of the vehicle. Lane line data are originally from front camera data of the camera 30. However, in this example, the lane lines 32 are processed data (polynomial curves), instead of camera images.

As non-limiting examples, the vehicles may be pickup trucks, sedans, coupes, sport utility vehicles (SUVs), recreational vehicles (RVs), etc. Each of the vehicles may be in wireless communication with the system controller 40 and includes one or more sensors. The sensors collect information and generate sensor data indicative of the collected information.

Each of the vehicles 22, 26 may include one or more vehicle controller 34 in communication with the sensors. The vehicle controller 34 includes at least one processor and a non-transitory computer readable storage device or media. The processor may be a custom made or commercially available processor, a central processing unit (CPU), a graphics processing unit (GPU), an auxiliary processor among several processors associated with the vehicle controller 34, a semiconductor-based microprocessor (in the form of a microchip or chip set), a macroprocessor, a combination thereof, or generally a device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down.

The computer-readable storage device or media of the vehicle controller 34 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 34 in controlling the vehicle. For example, the vehicle controller 34 may be configured to autonomously control the movements of the vehicle.

Each of the vehicles may include an output device 36 in communication with the vehicle controller 34. The term “output device” is a device that receives data from the vehicle controller 34 and carries data that has been processed by the vehicle controller 34 to the user. As a non-limiting example, the output device 36 may be a display in the vehicle.

Referring to FIG. 1, the system 10 further comprises the system controller 40 in communication with the first vehicle 22 and the second vehicles 26. The system controller 40 is programmed to receive the sensor data (e.g., sensed lane line data and vehicle GPS data) from the vehicles and may be configured as a cloud-based system. The sensed lane line data includes information about the lane lines 32 observed by the cameras 30, such as lane line color, lane line type (e.g., solid or broken lines), geometry of the lane line 32. The vehicle GPS data is indicative of the location of the vehicle.

Generally, the system controller 40 is configured to receive sensor data collected by the sensors of the vehicles. The vehicles send the sensor data to the system controller 40. Using, among other things, the sensor data from the vehicles, the system controller 40 is programmed to construct a lane line map using the probability density bitmaps. Then, the system controller 40 outputs a high-definition (HD) map 14, including details about the lane lines 32 of the roadway 12. In the present disclosure, the term “HD map” means a highly precise map used in autonomous driving, which contains details at a centimeter level.

As shown FIGS. 1-3, the HD map 14 includes a representation of the roadway 12 and the lane lines 32. In the present disclosure, the term “lane line” means a solid or broken paint line or other marker line separating lanes of traffic moving in the same direction or opposite directions. HD map 14 may be shown to the vehicle user through the output device 36 (e.g., display).

As shown, the system controller 40 comprises at least one processor 42 and a non-transitory computer-readable storage device 44 in communication with the processor 42. The computer-readable storage device 44 or the processor 42 is arranged to receive the first bitmap data from the first vehicle 22 and the second bitmap data from the second vehicles 26. The processor 42 may be a custom made or commercially available processor, a central processing unit (CPU), a graphics processing unit (GPU), an auxiliary processor among several processors associated with the system controller 40, a semiconductor-based microprocessor (in the form of a microchip or chip set), a macroprocessor, a combination thereof, or generally a device for executing instructions. The computer readable storage device or media 44 may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media 44 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions. The system controllers may be programmed to execute the methods below described in detail below, such as method 110 discussed below and shown in FIG. 5.

The instructions may include one or more separate programs, each of which comprises an ordered listing of executable instructions for implementing logical functions. The instructions, when executed by the processor, receive and process signals from the sensors, perform logic, calculations, methods and/or algorithms for automatically controlling the components of the vehicle, and generate control signals to an actuator system to automatically control the components of the vehicle based on the logic, calculations, methods, and/or algorithms. Although a single system controller 40 is shown in FIG. 1, embodiments of the system 10 may include a plurality of system controllers that communicate over a suitable communication medium or a combination of communication mediums and that cooperate to process the sensor signals, perform logic, calculations, methods, and/or algorithms, and generate control signals to automatically control features of the system 10. In various embodiments, one or more instructions of the system controller 40 are embodied in the system 10. The non-transitory computer readable storage device or media 44 includes machine-readable instructions that, when executed by the one or more processors, cause the processors to execute method 110 discussed herein and shown in FIG. 5.

Referring back to FIG. 1, the processor 42 is arranged to create a plurality of first multi-layer bitmaps for the first vehicle 22 using the first bitmap data and to create a plurality of second multi-layer bitmaps for each second vehicle using the second bitmap data. In doing so, the system controller 40 may use GPS data, lane line data, heading data, and speed data of the plurality of vehicles. Each of the first multi-layer bitmaps has at least one lane line attribute (e.g., yellow lane line, white lane line, dashed lane line).

Moreover, the processor 42 is arranged to plot lane lines 32 to the first multi-layer bitmaps of the first vehicle 22 using the first lane line data to define first plotted bitmaps. Then, the processor 42 creates first multi-layer probability density bitmaps with the first plotted bitmaps by way of a probability density estimation to represent observed lane lines 32. Each of the first probability density bitmaps corresponds to a lane line attribute (e.g., yellow lane line, white lane line, solid lane line, broken lane line).

Further, the processor 42 is arranged to plot lane lines 32 to the second multi-layer bitmaps of the second vehicles 26 using the second lane line data to define second plotted bitmaps. Then, the processor 42 merges the second plotted bitmaps of each of the second vehicles 26, defining an overall lane line bitmap. In addition, the processor 42 is arranged to create an overall multi-layer probability density bitmap with the overall lane line bitmap by way of the probability density estimation to represent observed lane lines 32.

It is to be understood that the system controller 40 or processor 42 may apply a probability density estimation such as a kernel density estimation (KDE) as known in the art to create the first probability density bitmaps and the overall probability density bitmap. Each multi-layer probability density bitmap is a probability density function, which is a function whose value at any given sample (or point) in the sample space (the set of possible values taken by the random variable) can be interpreted as providing a relative likelihood that the value of the random variable would be close to that sample. Other methods, such as Gaussian blur, may be used instead of KDE without departing from the spirit or scope of the present disclosure.

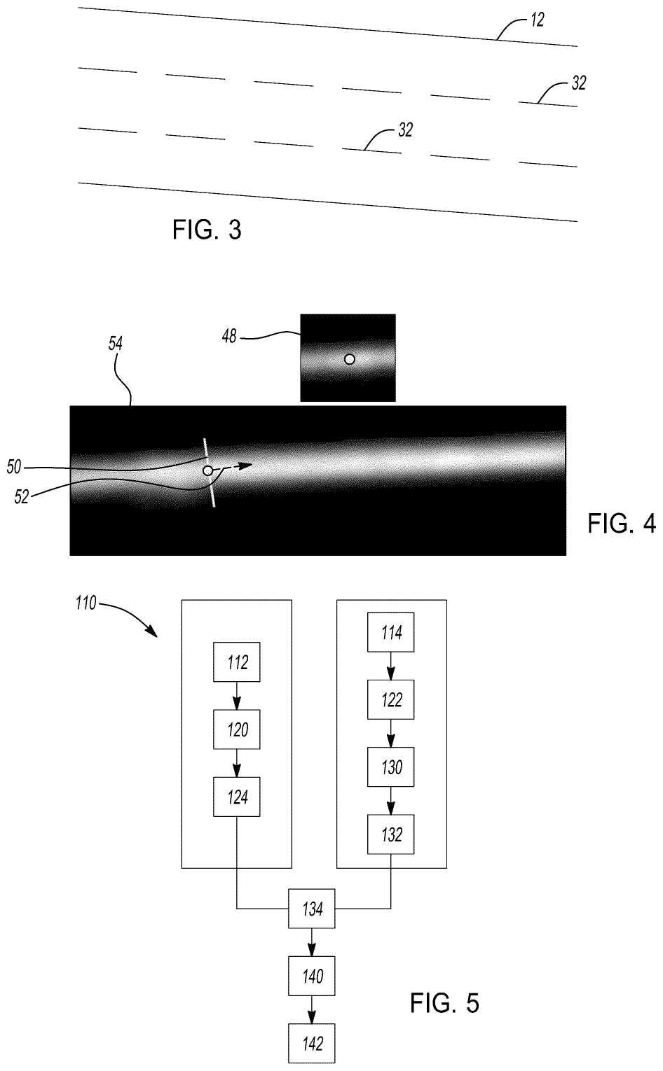

In this embodiment, the system controller 40 generally constructs the lane lines 32 of the roadway 12 using the first multi-layer probability density bitmaps and the overall multi-layer probability density bitmap (FIG. 3) as described in greater detail below. To do so, the processor 42 may use a local search algorithm, such as a hill climbing algorithm. In each probability density bitmap, each pixel (x,y) represents the probability of a lane line observed by crowdsourcing vehicles at a location (longitude, latitude). The pixel coordinates (x,y) may be uniquely converted to or from the global coordinates. The brightness of a pixel represents the probability of an observed lane line. A pixel brightness value of zero represents zero probability of a lane line, and a pixel brightness value of one represents a 100% probability of a lane line.

Referring to FIGS. 1 and 4, the system controller 40 is arranged to extract an image template from each of the first probability density bitmaps wherein each image template corresponds to the first lane line data (e.g., geometry, type (i.e., solid or broken), and color of the lane lines). That is, each image template comprises the first lane line data of one lane line attribute (e.g. yellow lane line). For example, the lane line attributes may be determined by analyzing separate layers of the first probability density bitmaps. The processor 42 extracts or processes a rectangular sub-image from the first bitmap data of the first sensor 20, defining an extracted sub-image 48. In this example, the sub-image 48 may be centered at a coordinate (x,y) and may have a width (w) and a height (h) according to the first bitmap data wherein (w) and (h) are system parameters. Such extracted sub-image defines an image tem plate.

Upon extraction of the image templates, the processor 42 is arranged to match the image template 48 (template matching) from each of the first probability density bitmaps with the overall probability density bitmap 54 for the timestamp (e.g., t₁), defining a plurality of match results having utility values at the timestamp. As an example, FIG. 4 depicts an extracted sub-image or image template matched with an overall probability density bitmap. Relative to the timestamp, each match result is limited along a line perpendicular to the trajectory of the first vehicle 22, and centered relative to the first GPS data and first lane line data of the first vehicle 22 to define a limited search scope. The limited search scope avoids a high volume of match results thereby reducing calculation overhead.

That is, referring to FIG. 4, the processor 42 applies the image template 48 extracted from the first probability density bitmap onto the overall probability density bitmap 54 at the timestamp. In this example, the processor 42 finds the first vehicle original GPS position at the timestamp (t,x,y). Then, the processor 42 applies or draws a line segment 50 having a center which is centered at (x,y) and is perpendicular to the first vehicle's moving heading or trajectory 52. The line segment 50 may be any suitable length based on known GPS error. For example, the line segment 50 may be for example +/−10 meters therealong relative to the center (x,y) where known GPS is for example +/−4 meters. The line segment 50 represents the limited search scope and pixels residing on the line segment 50 define the match results. Such limited search scope can significantly reduce computing overhead.

One object of the template matching above is to find a matching location along the line segment 50 where a maximal utility value (discussed below) can be generated. The maximal utility value represents a position where the first vehicle's observed lane line position (one of the first probability density bitmaps) matches an average of the second vehicles' observed lane line position (the overall probability density bitmap). The maximal utility value position represents a potential GPS correction which can be applied to the first vehicle's trajectory.

Referring back to FIG. 1, the processor 42 is arranged to combine the match results and utility values to define combined utility values. In one example, the processor 42 combines the match results and utility values by way of a first equation:

$$util\_combined ( i , j ) = {\sum }_{layer \_ k} u t i {l}_{layer \_} k ( i , j ) , ( i , j ) ∈ search\_scope$$

where (i,j) is a pixel from the search scope, util_layer_k(i,j) is the utility value of the template matching at pixel (i,j) for a layer k, and util_combined(i,j) is the combined utility value of all the layers k at pixel (i,j) at the timestamp.

Furthermore, the processor 42 is arranged to determine a maximal utility value with the combined utility values for correcting the GPS vehicle trajectory of the first vehicle 22. That is, the processor 42 determines the maximal utility value by way of a second equation:

$$( {x}^{′} , {y}^{′} ) = {argmax}_{( i , j )} ( util\_combined ( i , j ) )$$

where argmax is a function to provide the maximal utility value of the util_combined(i,j), (x′,y′) is a corrected GPS trajectory position of the first vehicle 22 having input (t,x,y), where t is the timestamp and (x,y) is first GPS data of the first vehicle 22.

It is to be understood that the processor 42 of the system controller 40 processes bitmap data of each timestamp (e.g., t₁). Bitmap data for a plurality of timestamps (tₙ) may be received from the vehicles. Thus, after the processor 42 determines the maximal utility value at the timestamp, the processor 42 is arranged to check whether bitmap data for all timestamps (t₁, t₂, t₃ . . . tₙ) or points have been processed. In a situation where not all bitmaps for all timestamps have been processed, the system 10 processes bitmap data for a remainder of timestamps. In a situation where all bitmaps for all timestamps have been processed, computation is complete and the corrected GPS trajectory position is used to update the HD map 14 which is ultimately reflected by the output devices 36 of the vehicles 22, 26 for users to view.

FIG. 5 depicts a flowchart of a method 110 of correcting a GPS vehicle trajectory on a roadway for a high-definition map 14 in accordance with one example of the present disclosure. In this example, the method 110 is implemented by the system 10 discussed above. As shown in block 112, the method 110 comprises the system controller 40 or storage device 44 receiving first bitmap data from a first sensor 20 of a first vehicle 22 to create a plurality of first multi-layer bitmaps for the first vehicle 22 using the first bitmap data. The first bitmap data comprises first GPS data and first lane line data at a timestamp. Each of the first multi-layer bitmaps has at least one lane line attribute. As discussed above, the processor 42 may create the plurality of first multi-layer bitmaps for the first vehicle 22 using the first bitmap data. Furthermore, it is to be understood that the at least one lane line attribute comprises lane line types such as yellow lane lines, white lane lines, solid lane lines, and broken lane line.

In block 114, the method 110 further comprises the system controller 40 or storage device 44 receiving second bitmap data from a plurality of second sensors 24 of a plurality of second vehicles 26 to create a plurality of second multi-layer bitmaps for each second vehicle using the second bitmap data. The second bitmap data comprises second GPS data and second lane line data at the timestamp of each second vehicle. As discussed, the processor 42 may create the plurality of second multi-layer bitmaps for each second vehicle using the second bitmap data.

As depicted in block 120, the method 110 further comprises the processor 42 plotting lane lines 32 to the first multi-layer bitmaps of the first vehicle 22 using the first lane line data to define first plotted bitmaps. In block 122, the method 110 further comprises the processor 42 plotting lane lines 32 to the second multi-layer bitmaps of the second vehicles 26 using the second lane line data to define second plotted bitmaps.

As shown in block 124, the method 110 further comprises the processor 42 creating first probability density bitmaps with the first plotted bitmaps by way of the probability density estimation discussed above. In block 130, the method 110 comprises the processor 42 merging the second plotted bitmaps of each of the second vehicles 26 to define an overall lane line bitmap. Furthermore, the method 110 comprises in block 132 the processor 42 creating an overall probability density bitmap with the overall lane line bitmap by way of the probability density estimation discussed above.

As previously discussed, the processor 42 then extracts an image template from each of the first probability density bitmaps wherein each image template comprises the first lane line data. In block 134, the method 110 further comprises the processor 42 matching an image template from each of the first probability density bitmaps with the overall probability density bitmap to define a plurality of match results having utility values. In this example, each image template comprises the first lane line data of one lane line attribute. As previously mentioned, each match result of each lane line attribute is limited along a line perpendicular to the trajectory of the first vehicle 22 and each match result being centered relative to the first GPS data and first lane line data of the first vehicle 22 to define a search scope.

As depicted in block 140, the method 110 further comprises the processor 42 combining the match results and utility values to define a combined utility value by way of:

$$util\_combined ( i , j ) = {\sum }_{layer \_ k} u t i {l}_{layer \_} k ( i , j ) , ( i , j ) ∈ search\_scope$$

where (i,j) is a pixel from the search scope, util_layer_k(i,j) is the utility value of the template matching at pixel (i,j) for a layer k, util_combined(i,j) is the combined utility value of all the layers k at pixel (i,j).

The method 110 further comprises in block 142 the processor 42 determining a maximal utility value to correct the GPS vehicle trajectory of the first vehicle 22 for a high-definition map 14 by way of:

$$( {x}^{′} , {y}^{′} ) = {argmax}_{( i , j )} ( util\_combined ( i , j ) )$$

where argmax is a function that provides the maximal utility value of the util_combined(i,j), (x′,y′) is a corrected GPS trajectory position of the first vehicle 22 having input (t,x,y), where t is the timestamp and (x,y) is first GPS data of the first vehicle 22.

It is to be understood that the method 110 described above is performed by the system 10 for bitmap data of each timestamp (e.g., t₁). Bitmap data for a plurality of timestamps (tₙ) may be received from the vehicles. Thus, after the step of determining the maximal utility value, the processor 42 is arranged to check whether bitmap data for all timestamps (t₁, t₂, t₃ . . . tₙ) or points have been processed. In a situation where not all bitmaps for all timestamps have been processed, the method 110 processes bitmap data for a remainder of timestamps. In a situation where all bitmaps for all timestamps have been processed, computation is complete and the corrected GPS trajectory position is used to update the HD map 14 which is ultimately reflected by the output devices 36 of the vehicles for users to view.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of correcting a GPS vehicle trajectory of a vehicle on a roadway for a high-definition map, the method comprising:
receiving first bitmap data from a first sensor of a first vehicle, the first bitmap data comprising first GPS data and first lane line data at a timestamp to create a plurality of first multi-layer bitmaps for the first vehicle using the first bitmap data, each of the first multi-layer bitmaps having at least one lane line attribute;
receiving second bitmap data from a plurality of second sensors of a plurality of second vehicles, the second bitmap data comprising second GPS data and second lane line data at the time segment of each second vehicle to create a plurality of second multi-layer bitmaps for each second vehicle using the second bitmap data;
creating first probability density bitmaps with the first multi-layer bitmaps and the first lane line data by way of a probability density estimation;
creating an overall probability density bitmap with the second multi-layer bitmaps and the second lane line data by way of the probability density estimation;
matching an image template from each of the first probability density bitmaps with the overall probability density bitmap for the timestamp to define a plurality of match results having utility values, each image template comprising the first lane line data of one lane line attribute, each match result being limited along a line perpendicular to the trajectory of the first vehicle and centered relative to the first GPS data and first lane line data of the first vehicle to define a search scope;
combining the match results and utility values to define combined utility values; and
determining the maximal utility value with the combined utility values to correct the GPS vehicle trajectory of the first vehicle for a high-definition map.

2. The method of claim 1 wherein the step of receiving the first bitmap data comprises creating the plurality of first multi-layer bitmaps for the first vehicle using the first bitmap data and wherein the step of receiving the second bitmap data comprises creating the plurality of second multi-layer bitmaps for each second vehicle using the second bitmap data.

3. The method of claim 1 wherein the step of creating the first probability density bitmaps comprises:
plotting lane lines to the first multi-layer bitmaps of the first vehicle using the first lane line data to define first plotted bitmaps; and
creating the first probability density bitmaps with the first plotted bitmaps by way of the probability density estimation.

4. The method of claim 1 wherein the step of creating the overall probability density bitmap comprises:
plotting lane lines to the second multi-layer bitmaps of the second vehicles using the second lane line data to define second plotted bitmaps;
merging the second plotted bitmaps of each of the second vehicles to define an overall lane line bitmap; and
creating the overall probability density bitmap with the overall lane line bitmap by way of the probability density estimation;

5. The method of claim 1 wherein the step of matching comprises:
extracting the image template from each of the first probability density bitmaps, each image template comprising the first lane line data.

6. The method of claim 1 wherein the step of combining comprises:
combining the match results and utility values to define the combined utility value by way of:
$$util\_combined ( i , j ) = {\sum }_{layer \_ k} u t i {l}_{layer \_} k ( i , j ) , ( i , j ) ∈ search\_scope$$
where (i,j) is a pixel from the search scope, util_layer_k(i,j) is the utility value of the template matching at pixel (i,j) for a layer k, util_combined(i,j) is the combined utility value of all the layers k at pixel (i,j).

7. The method of claim 6 wherein the step of determining comprises:
determining the maximal utility value by way of:
$$( {x}^{′} , {y}^{′} ) = {argmax}_{( i , j )} ( util\_combined ( i , j ) )$$
where argmax is a function to provide the maximal utility value of the util_combined(i,j), (x′,y′) is a corrected GPS trajectory position of the first vehicle having input (t,x,y), where t is the timestamp and (x,y) is first GPS data of the first vehicle.

8. The method of claim 1 wherein the at least one lane line attribute comprises lane line types including yellow lane lines, white lane lines, solid lane lines, and dashed lane line.

9. The method of claim 1 wherein the timestamp comprises a plurality of timestamps.

10. A method of correcting a GPS vehicle trajectory on a roadway for a high-definition map, the method comprising:
receiving first bitmap data from a first sensor of a first vehicle, the first bitmap data comprising first GPS data and first lane line data at a timestamp to create a plurality of first multi-layer bitmaps for the first vehicle using the first bitmap data, each of the first multi-layer bitmaps having at least one lane line attribute;
receiving second bitmap data from a plurality of second sensors of a plurality of second vehicles, the second bitmap data comprising second GPS data and second lane line data at the time segment of each second vehicle to create a plurality of second multi-layer bitmaps for each second vehicle using the second bitmap data;
plotting lane lines to the first multi-layer bitmaps of the first vehicle using the first lane line data to define first plotted bitmaps;
plotting lane lines to the second multi-layer bitmaps of the second vehicles using the second lane line data to define second plotted bitmaps;
creating first probability density bitmaps with the first plotted bitmaps by way of a probability density estimation;
merging the second plotted bitmaps of each of the second vehicles to define an overall lane line bitmap;
creating an overall probability density bitmap with the overall lane line bitmap by way of the probability density estimation;
matching an image template from each of the first probability density bitmaps with the overall probability density bitmap to define a plurality of match results having utility values, each image template comprising the first lane line data of one lane line attribute, each match result of each lane line attribute being limited along a line perpendicular to the trajectory of the first vehicle and each match result being centered relative to the first GPS data and first lane line data of the first vehicle to define a search scope;
combining the match results and utility values to define a combined utility value by way of:
$$util\_combined ( i , j ) = {\sum }_{layer \_ k} u t i {l}_{layer \_} k ( i , j ) , ( i , j ) ∈ search\_scope$$
where (i,j) is a pixel from the search scope, util_layer_k(i,j) is the utility value of the template matching at pixel (i,j) for a layer k, util_combined(i,j) is the combined utility value of all the layers k at pixel (i,j); and
determining a maximal utility value to correct the GPS vehicle trajectory of the first vehicle for a high-density map by way of:
$$( {x}^{′} , {y}^{′} ) = {argmax}_{( i , j )} ( util\_combined ( i , j ) )$$
where argmax is a function that provides the maximal utility value of the util_combined(i,j), (x′,y′) is a corrected GPS trajectory position of the first vehicle having input (t,x,y), where t is the timestamp and (x,y) is first GPS data of the first vehicle.

11. The method of claim 10 wherein the step of receiving the first bitmap data comprises creating the plurality of first multi-layer bitmaps for the first vehicle using the first bitmap data and wherein the step of receiving the second bitmap data comprises creating the plurality of second multi-layer bitmaps for each second vehicle using the second bitmap data.

12. The method of claim 10 wherein the step of matching comprises:
extracting the image template from each of the first probability density bitmaps, each image template comprising the first lane line data.

13. The method of claim 10 wherein the at least one lane line attribute comprises lane line types including yellow lane lines, white lane lines, solid lane lines, and dashed lane line.

14. The method of claim 10 wherein the timestamp comprises a plurality of timestamps.

15. A system for correcting a GPS vehicle trajectory on a roadway for a high-definition map, the system comprising:
a first sensor of a first vehicle on the roadway, the first sensors arranged to sense first bitmap data comprising first GPS data and first lane line data at a timestamp;
a plurality of second sensors of a plurality of second vehicles on the roadway, the second sensors arranged to sense second bitmap data comprising second GPS data and second lane line data at the time segment of each second vehicle;
a system controller in communication with the first vehicle and the second vehicles, the system controller comprising:
a computer-readable storage device arranged to receive the first bitmap data from the first vehicle and the second bitmap data from the second vehicles;
a processor in communication with the computer-readable storage device, the processor arranged to create a plurality of first multi-layer bitmaps for the first vehicle using the first bitmap data, each of the first multi-layer bitmaps having at least one lane line attribute and to create a plurality of second multi-layer bitmaps for each second vehicle using the second bitmap data, the system controller arranged to create first probability density bitmaps with the first multi-layer bitmaps and the first lane line data by way of a probability density estimation, the system controller arranged to create an overall probability density bitmap with the second multi-layer bitmaps and the second lane line data by way of the probability density estimation;
wherein the processor is arranged to match an image template from each of the first probability density bitmaps with the overall probability density bitmap for the timestamp defining a plurality of match results having utility values, each image template comprising the first lane line data of one lane line attribute, each match result being limited along a line perpendicular to the trajectory of the first vehicle and centered relative to the first GPS data and first lane line data of the first vehicle to define a search scope, the processor arranged to combining the match results and utility values to define combined utility values and to determine a maximal utility value with the combined utility values for correcting the GPS vehicle trajectory of the first vehicle.

16. The system of claim 15 wherein the system controller is arranged to plot lane lines to the first multi-layer bitmaps of the first vehicle using the first lane line data to define first plotted bitmaps and to create the first probability density bitmaps with the first plotted bitmaps by way of the probability density estimation.

17. The system of claim 15 wherein the system controller is arranged to plot lane lines to the second multi-layer bitmaps of the second vehicles using the second lane line data to define second plotted bitmaps and merge the second plotted bitmaps of each of the second vehicles to define an overall lane line bitmap, the system controller is arranged to create the overall probability density bitmap with the overall lane line bitmap by way of the probability density estimation;

18. The system of claim 15 wherein the processor is arranged to extract the image template from each of the first probability density bitmaps, each image template comprising the first lane line data.

19. The system of claim 15 wherein the processor is arranged to combine the match results and utility values to define the combined utility value by way of:
$$util\_combined ( i , j ) = {\sum }_{layer \_ k} u t i {l}_{layer \_} k ( i , j ) , ( i , j ) ∈ search\_scope$$
where (i,j) is a pixel from the search scope, util_layer_k(i,j) is the utility value of the template matching at pixel (i,j) for a layer k, util_combined(i,j) is the combined utility value of all the layers k at pixel (i,j).

20. The system of claim 19 wherein the processor is arranged to determine the maximal utility value by way of:
$$( {x}^{′} , {y}^{′} ) = {argmax}_{( i , j )} ( util\_combined ( i , j ) )$$
where argmax is a function to provide the maximal utility value of the util_combined(i,j), (x′,y′) is a corrected GPS trajectory position of the first vehicle having input (t,x,y), where t is the timestamp and (x,y) is first GPS data of the first vehicle.
